(19) United States
(12) Patent Application Publication
(10) Pub. No.: US 2025/0115433 A1
(43) Pub. Date: Apr. 10, 2025

(54) APPARATUS AND METHOD FOR CARRYING HEAVY OBJECTS

(71) Applicant: Robert Marion Cato, Fuquay Varina, NC (US)

(72) Inventor: Robert Marion Cato, Fuquay Varina, NC (US)

(21) Appl. No.: 18/828,680

(22) Filed: Sep. 9, 2024

Related U.S. Application Data
(60) Provisional application No. 63/587,995, filed on Oct. 4, 2023.

(51) Int. Cl. B65G 7/12

(52) U.S. Cl. CPC B65G 7/12

(57) ABSTRACT

A carrying device for allowing a user to carry large objects including a shoulder harness having a first strap for support with a left shoulder of a user and a second strap for support with a right shoulder of a user. A buckle includes a buckle base plate having a width and a height, with the width larger than the height. The buckle has a strap slot disposed horizontally along the width of the buckle base plate and a first angled slot disposed adjacent a second angled slot positioned above the strap slot. A carrying strap has a first strap end for passing through the strap slot. A handle is secured to a second strap end opposite the first strap end. The shoulder harness is adjustably securable to the first and second angled slots, and the carrying strap is adjustably securable to the strap slot.

### CROSS-REFERENCE TO RELATED APPLICATIONS

This application is a Utility patent application claiming priority to U.S. Provisional Patent Application Ser. No. 63/587,995, filed on Oct. 4, 2023, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates in general to the field of material handling and, more particularly, a strap system for allowing a person to move heavy objects.

### Description of Related Art

Carrying large and heavy objects has long been a challenge for individuals in various settings, including home moving, furniture delivery, and construction work. Traditional methods of carrying such objects often involve manual lifting, which can lead to physical strain, fatigue, and potential injuries. The need for efficient and ergonomic solutions to transport bulky items has been a persistent concern across multiple industries and everyday life situations.

Existing carrying aids, such as dollies, hand trucks, and moving straps, have provided some assistance in transporting large objects. However, these tools often have limitations in terms of versatility, ease of use, or the types of objects they can effectively handle. For instance, dollies and hand trucks are primarily designed for use on flat surfaces and may struggle with stairs or uneven terrain. Moving straps, while more adaptable, can be challenging to adjust and may not distribute weight evenly across the user's body.

The ergonomics of carrying heavy loads have been a subject of ongoing research and development. Proper weight distribution and body mechanics are crucial for reducing the risk of injury and improving the overall carrying experience. However, many existing carrying devices fail to adequately address these ergonomic considerations, potentially leading to user discomfort or strain during extended use.

Additionally, the adaptability of carrying devices to accommodate various object sizes and shapes has been a persistent challenge. Many carrying aids are designed for specific types of items, limiting their utility across different applications. This lack of versatility often requires users to own and transport multiple specialized tools, which can be impractical and costly.

Furthermore, the ease of setup and adjustment of carrying devices plays a significant role in their adoption and effective use. Complex or time-consuming setup procedures can discourage users from employing these aids, especially in situations where quick and efficient object transportation is necessary.

As the demand for practical solutions to carry large and heavy objects continues to grow, there remains a need for innovative carrying devices that address these longstanding challenges. Improvements in ergonomics, versatility, ease of use, and adaptability could significantly enhance the experience of transporting bulky items across various contexts and user needs.

Large, cumbersome and/or heavy objects are difficult to carry and may cause physical stress or injury. There are a few products on the market that allow two people to lift and carry such objects while distributing the weight of the object to their shoulders. A device is needed which allows the same ability for one person to carry such objects while distributing much of the weight to their shoulders. The device should allow a person to carry large, heavy shutter panel boxes (similar in size and weight of a full-size folding banquet table or slab of sheetrock) but the device should carry items of various size, shape and weight. The device should also be able to carry cumbersome bundles of items, such as multiple long thin boxes or items such as a bundle of 2×4 wood studs.

Devices exist for two people to carry large cumbersome objects with the weight supported by the shoulders, but none allow one person to carry large, heavy objects by supporting much of the weight with the shoulders while allowing for adjustments for carrying objects of various size and shape. Such devices currently exist with slightly different designs and all requiring two people to work in tandem, each wearing a shoulder harness, and a strap connects to an adjustable buckle attached to each shoulder harnesses. A device exists on the market that is a long wide strap with a handle on each end, one of which is adjustable to lengthen or shorten the strap. It requires two hands to carry objects and does not distribute the weight to the shoulders of the user. A device usually used by two people needs to now be utilized by one person with similar results. These and other objects, features, and advantages of the present invention will become more readily apparent from the attached drawings and the detailed description of the preferred embodiments, which follow.

### SUMMARY OF THE INVENTION

According to an aspect of the present disclosure, a carrying device for allowing a user to carry large objects is provided. The carrying device includes a shoulder harness having a first strap for support with a left shoulder of a user and a second strap for support with a right shoulder of a user. The carrying device also includes a buckle. The buckle includes a buckle base plate having a width and a height, the width larger than the height, a strap slot disposed horizontally along the width of the buckle base plate, and a first angled slot disposed adjacent a second angled slot, the first and second angled slots positioned above the strap slot. The carrying device further includes a carrying strap having a first strap end for passing through the strap slot, and a handle secured to a second strap end of the carrying strap, the second strap end opposite the first strap end. The shoulder harness is adjustably securable to the first and second angled slots, and the carrying strap is adjustably securable to the strap slot.

According to other aspects of the present disclosure, the carrying device may include one or more of the following features. The carrying device may include a locking rod extending across the strap slot wherein the carrying strap is adjustably securable to the strap slot by the locking rod. The handle may comprise a grip portion and a strap attachment portion, the strap attachment portion for securely connecting the handle to the second strap end. The grip portion of the handle may be ergonomically shaped to fit a hand of the user. The shoulder harness may further include length adjustment on the first strap and the second strap to accommodate different user sizes. The buckle base plate may be made of a durable, lightweight material selected from the group consisting of aluminum, reinforced plastic, and titanium. The buckle base plate may further comprise reinforced edges to enhance structural integrity.

According to another aspect of the present disclosure, a method for carrying a large object is provided. The method includes providing a carrying device including a shoulder harness having a first strap for support with a left shoulder of a user and a second strap for support with a right shoulder of a user, a buckle including a buckle base plate with a strap slot and first and second angled slots, a carrying strap having a first strap end for passing through the strap slot, and a handle secured to a second strap end of the carrying strap. The method also includes attaching the shoulder harness against shoulders of a user, passing the first strap end through the strap slot, securing the carrying strap along a portion of a large object, positioning the large object on the carrying strap, adjusting the handle position so the large object is held by the carrying strap, and carrying the large object to a desired location.

According to other aspects of the present disclosure, the method may include one or more of the following features. The method may further comprise adjusting a length of the first strap and the second strap of the shoulder harness to fit the user. Securing the carrying strap along a portion of the large object may comprise wrapping the carrying strap around the large object at least once. Adjusting the handle position may comprise pulling the handle to tighten the carrying strap around the large object. The method may further comprise passing the first strap end through a locking rod extending across the strap slot to secure the carrying strap in place. Adjusting the handle position may comprise sliding the carrying strap through the strap slot and locking rod to adjust the length of the carrying strap supporting the large object. The large object may be selected from the group consisting of a mattress, a piece of furniture, a large appliance, and a bundle of construction materials.

One aspect of the invention is directed to a carrying device for allowing a user to carry large objects. The carrying device includes a shoulder harness having a first strap for support with a left shoulder of a user and a second strap for support with a right shoulder of a user. The carrying device includes a buckle having a buckle base plate width and a height, the width larger than the height. The buckle includes a strap slot disposed horizontally along the width of the buckle base plate and a first angled slot disposed adjacent a second angled slot, the first and second angled slots positioned above the strap slot. The carrying device includes a carrying strap having a first strap end for passing through the strap slot and a handle secured to a second strap end of the carrying strap, the second strap end opposite the first strap end. The shoulder harness is adjustably securable to the first and second angled slots. The carrying strap is adjustably securable to the strap slot. The carrying device may include a locking rod extending across the strap slot wherein the carrying strap is adjustably securable to the strap slot by the locking rod. The handle may include a grip portion and a strap attachment portion, the strap attachment portion for securely connecting the handle to the second strap end. The grip portion of the handle may be ergonomically shaped to fit a hand of the user. The shoulder harness further may include a length adjustment on the first strap and the second strap to accommodate different user sizes. The buckle base plate may be made of a durable, lightweight material selected from the group consisting of aluminum, reinforced plastic, and titanium. The buckle base plate may include reinforced edges to enhance structural integrity.

Another aspect of the invention is directed to a method for carrying a large object. The method includes providing a carrying device including a shoulder harness having a first strap for support with a left shoulder of a user and a second strap for support with a right shoulder of a user, a buckle including a buckle base plate with a strap slot and first and second angled slots, a carrying strap having a first strap end for passing through the strap slot and a handle secured to a second strap end of the carrying strap. The method includes attaching the shoulder harness against shoulders of a user, passing the first strap end through the strap slot and securing the carrying strap along a portion of a large object. The method includes positioning the large object on the carrying strap, adjusting the handle position so the large object is held by the carrying strap and carrying the large object to a desired location. The method may include adjusting a length of the first strap and the second strap of the shoulder harness to fit the user. Securing the carrying strap along a portion of the large object may include wrapping the carrying strap around the large object at least once. Adjusting the handle position may include pulling the handle to tighten the carrying strap around the large object. The carrying device may include a locking rod disposed on the buckle extending across the strap slot for locking the carrying strap in the strap slot whereby the method includes passing the first strap end through the strap slot against the locking rod and locking the carrying strap in the strap slot. Adjusting the handle position may include sliding the carrying strap through the strap slot and locking rod to adjust the length of the carrying strap supporting the large object.

Another aspect of the invention is directed to a method for carrying a large object. The method includes providing a carrying device including a shoulder harness having a first strap for support with a left shoulder of a user and a second strap for support with a right shoulder of a user, a buckle including a buckle base plate with a strap slot and first and second angled slots, a carrying strap having a first strap end for passing through the strap slot and a handle secured to a second strap end of the carrying strap. The method includes attaching the shoulder harness against shoulders of a user, adjusting a length of the first strap and the second strap of the shoulder harness to fit the user, securing the carrying strap along a portion of a large object and passing the first strap end through the strap slot. The method includes positioning the large object on the carrying strap, adjusting the handle position so the large object is held by the carrying strap and carrying the large object to a desired location. Securing the carrying strap along a portion of the large object may include wrapping the carrying strap around the large object at least once. Adjusting the handle position may include pulling the handle to tighten the carrying strap around the large object. The carrying device may include a locking rod disposed on the buckle extending across the strap slot for locking the carrying strap in the strap slot and the method includes passing the first strap end through the strap slot against the locking rod and locking the carrying strap in the strap slot. Adjusting the handle position may include sliding the carrying strap through the strap slot and locking rod to adjust the length of the carrying strap supporting the large object.

The foregoing general description of the illustrative embodiments and the following detailed description thereof are merely exemplary aspects of the teachings of this disclosure and are not restrictive.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a strap harness on a user according to the present invention;

FIG. 2 is a flipped perspective view of the buckle according to the present invention;

FIG. 3 is a front view of a second embodiment of the buckle;

FIG. 4 shows a first step of a method for using the carrying device;

FIG. 5 shows a second step of the method for using the carrying device; and

FIG. 6 shows an opposite view of the second step of the method for using the carrying device.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms apparatus and device are used interchangeably when referring to the device for carrying a heavy object.

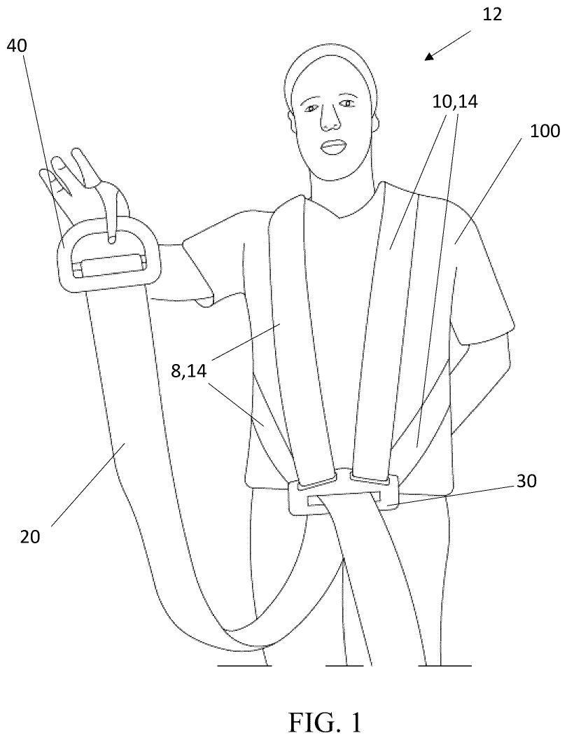

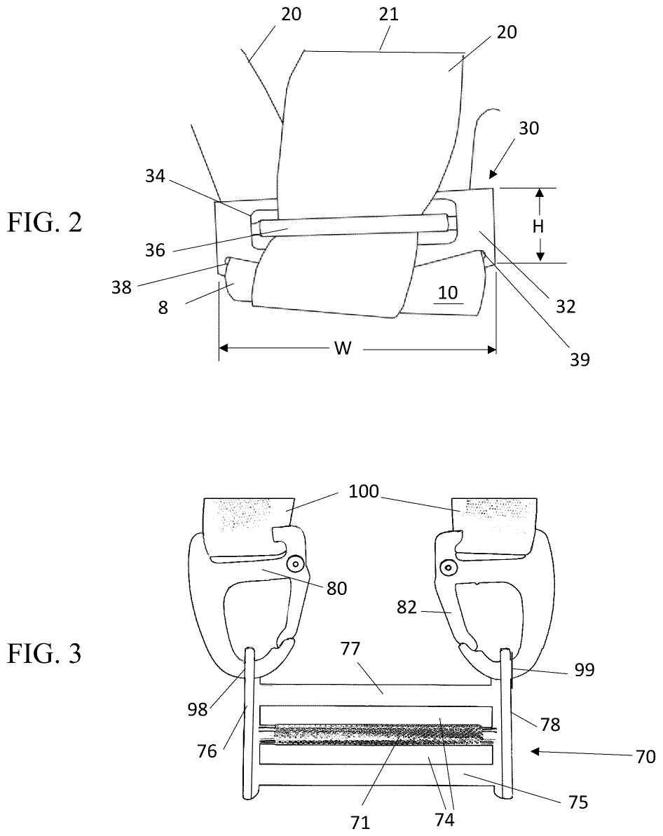

Now referring to the FIGS. 1-6, and more particularly to FIGS. 1, a carrying device 12 allows a user 100 to carry large objects. The carrying device 12 includes a shoulder harness 14 having a first strap 10 for support with a left shoulder of a user and a second strap 8 for support with a right shoulder of a user. The carrying device 12 includes a buckle 30 secured to the shoulder harness and a carrying strap 20 threaded through the buckle 30. The carrying strap 20 includes a handle 40 on one end and is connectable to the buckle by threading a carrying strap second end 21 through the buckle 30. In FIG. 2, the buckle 30 is flipped to show the rear side of the buckle and how the carrying strap 30 is threaded through the buckle 30. The buckle 30 includes a buckle base plate having a width W and a height H, the width larger than the height. The buckle 30 includes a strap slot 34 disposed horizontally along the width W of the buckle base plate 32 and a first angled slot 38 disposed adjacent a second angled slot 39, the first and second angled slots positioned above the strap slot 34 when the buckle 30 is in a normal position on the user as shown in FIG. 1. The carrying device includes a carrying strap having a first strap end for passing through the strap slot and a handle secured to a second strap end of the carrying strap, the second strap end opposite the first strap end. The shoulder harness is adjustably securable to the first and second angled slots. The carrying strap is adjustably securable to the strap slot. The carrying device may include a locking rod extending across the strap slot wherein the carrying strap is adjustably securable to the strap slot by the locking rod. The handle may include a grip portion and a strap attachment portion, the strap attachment portion for securely connecting the handle to the second strap end. The grip portion of the handle may be ergonomically shaped to fit a hand of the user. The shoulder harness further may include a length adjustment on the first strap and the second strap to accommodate different user sizes. The buckle base plate may be made of a durable, lightweight material selected from the group consisting of aluminum, reinforced plastic, and titanium. The buckle base plate may include reinforced edges to enhance structural integrity.

FIG. 3 shows an alternate embodiment of a buckle 70 having buckle side members 76, 78, upper and lower buckle bars 75, 77 spaced apart and extending between the buckle side members 76, 78. A locking rod 71 extends between the buckle side members 76, 78 in one direction and upper and lower buckle bars 75, 77 in a direction perpendicular to the buckle side members 76, 78. Buckle side members 76, 78 include openings 98, 99, respectively whereby the buckle 70 is attachable to clips 80, 82 disposed on ends of the shoulder harness 100.

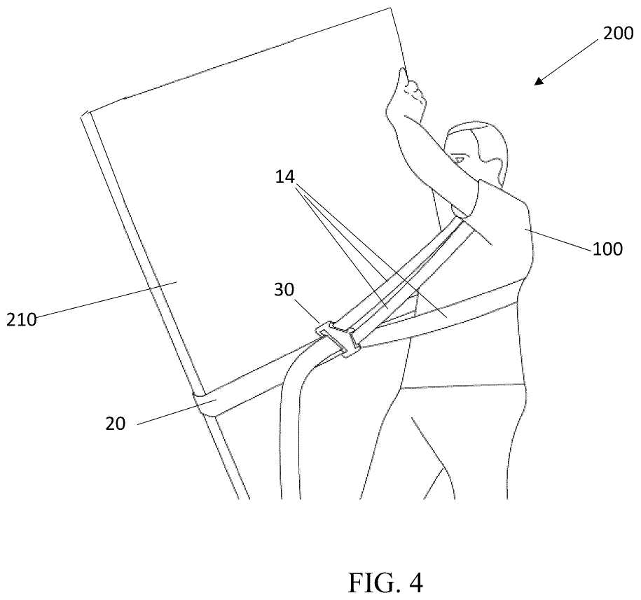

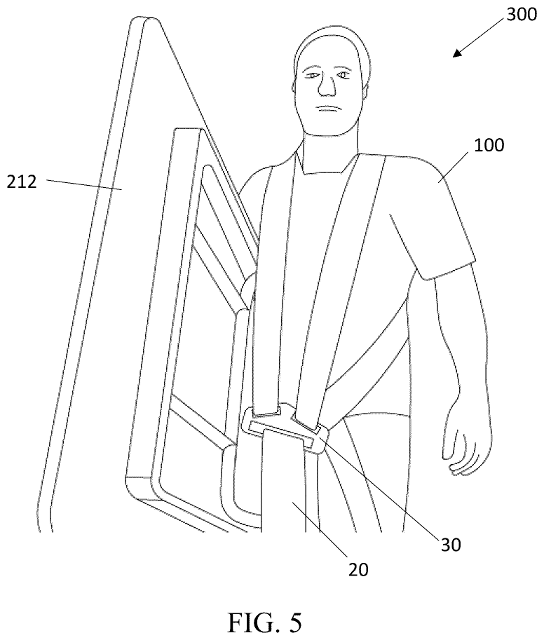

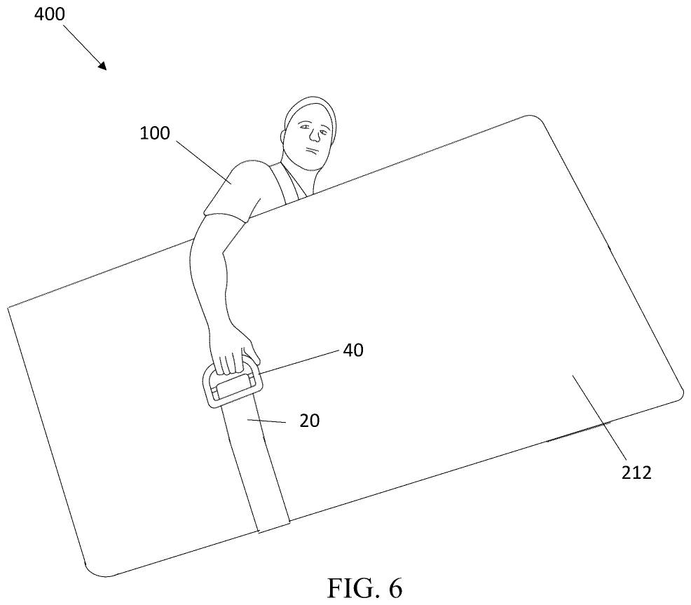

Another aspect of the invention is shown in FIGS. 1 and 4-6 and is directed to a method for carrying a large object. The method includes providing a carrying device as shown in FIG. 1. The method includes attaching the shoulder harness 14 against shoulders of a user 100 and passing the first strap end through the strap slot and securing the carrying strap along a portion of a large object. The method includes positioning the carrying device on a user as shown in FIG. 1. The method includes positioning the large object 210 on the carrying strap, adjusting the handle position so the large object is held by the carrying strap and carrying the large object to a desired location. The method includes a step of adjusting a length of the first strap and the second strap of the shoulder harness to fit the user. If the carrying device is already adjusted for the user, the shoulder harness adjustment may not be necessary. The method includes securing the carrying strap along a portion of the large object as shown in FIG. 4 and may include wrapping the carrying strap around the large object at least once. The method includes adjusting the handle position including pulling the handle to tighten the carrying strap around the large object. In one embodiment of the method, the carrying device may include a locking rod disposed on the buckle extending across the strap slot for locking the carrying strap in the strap slot whereby the method includes passing the first strap end through the strap slot against the locking rod and locking the carrying strap in the strap slot. Adjusting the handle position may include sliding the carrying strap through the strap slot and locking rod to adjust the length of the carrying strap supporting the large object. FIGS. 5 and 6 show two different perspective views of the user carrying the large object, the large object being a folded table 212.

Another aspect of the invention is directed to a method for carrying a large object. The method includes providing a carrying device including a shoulder harness having a first strap for support with a left shoulder of a user and a second strap for support with a right shoulder of a user, a buckle including a buckle base plate with a strap slot and first and second angled slots, a carrying strap having a first strap end for passing through the strap slot and a handle secured to a second strap end of the carrying strap. The method includes attaching the shoulder harness against shoulders of a user, adjusting a length of the first strap and the second strap of the shoulder harness to fit the user, securing the carrying strap along a portion of a large object and passing the first strap end through the strap slot. The method includes positioning the large object on the carrying strap, adjusting the handle position so the large object is held by the carrying strap and carrying the large object to a desired location. Securing the carrying strap along a portion of the large object may include wrapping the carrying strap around the large object at least once. Adjusting the handle position may include pulling the handle to tighten the carrying strap around the large object. The carrying device may include a locking rod disposed on the buckle extending across the strap slot for locking the carrying strap in the strap slot and the method includes passing the first strap end through the strap slot against the locking rod and locking the carrying strap in the strap slot. Adjusting the handle position may include sliding the carrying strap through the strap slot and locking rod to adjust the length of the carrying strap supporting the large object.

The user wears a shoulder harness with an attached adjustable buckle. A flat strap is fed through the buckle on one end, and a handle is attached to the flat strap on the other end to be held by the user in one hand. The user wraps the strap around the item to be carried, adjusts the length of the strap with their free hand, and shifts the weight of the item so that it is supported by the strap between the shoulder harness and the handle. The user may now carry the object with a large portion of the weight distributed to their shoulders. The user's free hand is available to balance the object being carried.

The present disclosure provides a carrying device designed to facilitate the transportation of large and heavy objects. The carrying device may include a shoulder harness, a buckle, and a carrying strap. The shoulder harness may be designed to distribute the weight of the object across the user's shoulders, potentially reducing strain and improving comfort during use. The shoulder harness may include a first strap for support with a left shoulder of a user and a second strap for support with a right shoulder of a user.

The buckle provides a secure and adjustable connection between the shoulder harness and the carrying strap. The buckle may include a buckle base plate, a strap slot, and first and second angled slots. The buckle base plate may have a width and a height, with the width being larger than the height. The strap slot may be disposed horizontally along the width of the buckle base plate, and the first and second angled slots may be positioned above the strap slot.

The carrying strap may be designed to securely hold the object being carried. The carrying strap may have a first strap end for passing through the strap slot, and a handle secured to a second strap end, the second strap end being opposite the first strap end. The handle may provide a convenient grip for the user, potentially enhancing control and stability during transportation.

In some cases, the shoulder harness may be adjustably securable to the first and second angled slots, and the carrying strap may be adjustably securable to the strap slot. This adjustable design may allow the carrying device to accommodate a variety of object sizes and user preferences, potentially enhancing its versatility and ease of use.

In some embodiments, the carrying device may include a locking rod extending across the strap slot, which may provide additional security and adjustability for the carrying strap. The carrying strap may be adjustably securable to the strap slot by the locking rod, potentially allowing for precise control over the tension and positioning of the carrying strap.

Overall, the carrying device may provide a practical and ergonomic solution for transporting large objects, potentially reducing physical strain and improving efficiency in various settings, such as home moving, furniture delivery, and construction work.

The shoulder harness may be designed to provide support to the user's shoulders, potentially distributing the weight of the object being carried and reducing strain. The shoulder harness may include a first strap and a second strap. The first strap may be designed for support with a left shoulder of a user, and the second strap may be designed for support with a right shoulder of a user. In some cases, the first and second straps may be symmetrically arranged, potentially providing balanced support and enhancing comfort during use.

In some aspects, the shoulder harness may include length adjustment features on the first and second straps. These length adjustment features may allow the user to adjust the length of the straps to fit their body size and the size of the object being carried. For example, the length adjustment features may include a series of holes or loops on the straps, and a pin or buckle for securing the straps at a desired length. In some cases, the length adjustment features may be designed to provide a wide range of adjustment, potentially accommodating a variety of user sizes and object sizes.

In some embodiments, the length adjustment features may include a sliding mechanism, such as a buckle or a clamp, which may allow the user to easily adjust the length of the straps by sliding the mechanism along the straps. The sliding mechanism may be designed to securely hold the straps at a desired length, potentially providing stable support and preventing slippage during use.

In some cases, the first and second straps of the shoulder harness may be made of a durable and flexible material, such as nylon, polyester, or leather. The material may be selected to provide a balance between strength, durability, and comfort. For example, the material may be strong enough to support the weight of the object being carried, durable enough to withstand repeated use, and comfortable enough to prevent discomfort or injury to the user's shoulders.

In some aspects, the first and second straps of the shoulder harness may be padded or cushioned to enhance comfort during use. The padding or cushioning may be made of a soft and resilient material, such as foam or gel, which may conform to the shape of the user's shoulders and reduce pressure points. In some cases, the padding or cushioning may be removable or adjustable, potentially allowing the user to customize the comfort and fit of the shoulder harness.

The buckle, a key component of the carrying device, may include a buckle base plate, a strap slot, and first and second angled slots. The buckle base plate may have a width and a height, with the width being larger than the height in some cases. This configuration may provide a wide and stable base for the buckle, potentially enhancing its strength and stability. The buckle base plate may be made of a durable and lightweight material, such as aluminum, reinforced plastic, or titanium, which may provide a balance between strength, durability, and weight.

The strap slot may be disposed horizontally along the width of the buckle base plate. This horizontal orientation may allow the carrying strap to pass through the strap slot in a straight line, potentially enhancing the stability and control of the carrying strap. In some cases, the strap slot may be sized to snugly accommodate the carrying strap, potentially preventing slippage and providing a secure connection between the carrying strap and the buckle.

Above the strap slot, the buckle base plate may include first and second angled slots. These angled slots may be positioned adjacent to each other and may be designed to accommodate the shoulder harness. In some cases, the first and second angled slots may be oriented at an angle relative to the horizontal plane, potentially allowing the shoulder harness to be secured at an angle that aligns with the natural slope of the user's shoulders. This angled orientation may enhance the comfort and fit of the shoulder harness, potentially reducing strain and improving the user's posture during use.

In some aspects, the first and second angled slots may be adjustably securable, potentially allowing the user to adjust the position and angle of the shoulder harness to fit their body size and the size of the object being carried. For example, the first and second angled slots may include a series of holes or loops, and a pin or buckle for securing the shoulder harness at a desired position and angle. In some cases, the first and second angled slots may include a sliding mechanism, such as a buckle or a clamp, which may allow the user to easily adjust the position and angle of the shoulder harness by sliding the mechanism along the slots.

The carrying strap of the device may include a handle secured to a second strap end, the second strap end being opposite the first strap end. The handle may provide a convenient grip for the user, potentially enhancing control and stability during transportation. In some cases, the handle may be permanently attached to the second strap end, such as by stitching, riveting, or bonding. In other cases, the handle may be removably attached to the second strap end, such as by a hook and loop fastener, a buckle, or a snap fastener, potentially allowing the user to replace or adjust the handle as needed.

The handle may comprise a grip portion and a strap attachment portion. The grip portion may be designed to be grasped by the user, and the strap attachment portion may be designed to securely connect the handle to the second strap end. In some cases, the grip portion and the strap attachment portion may be integrally formed, such as by molding or extrusion. In other cases, the grip portion and the strap attachment portion may be separately formed and then assembled, such as by fastening, bonding, or welding.

The grip portion of the handle may be ergonomically shaped to fit a user's hand. This ergonomic design may enhance the user's grip and reduce strain during use. For example, the grip portion may be contoured to match the shape of the user's fingers, or it may include a textured surface to enhance grip. In some cases, the grip portion may be adjustable, such as by including a series of grooves or ridges that can be adjusted to fit the user's hand size. In other cases, the grip portion may be padded or cushioned to enhance comfort during use.

In some aspects, the handle may be made of a durable and lightweight material, such as plastic, metal, or composite material. The material may be selected to provide a balance between strength, durability, and weight. For example, the material may be strong enough to withstand the weight of the object being carried, durable enough to withstand repeated use, and light enough to not add significant weight to the carrying device. In some cases, the handle may be coated or treated to enhance its grip, durability, or appearance. For example, the handle may be coated with a rubber or silicone material to enhance grip, or it may be treated with a corrosion-resistant finish to enhance durability.

In some aspects, the method for using the carrying device to transport large objects may begin with the user attaching the shoulder harness against their shoulders. This may involve positioning the first strap over the left shoulder and the second strap over the right shoulder. The shoulder harness may be adjusted to fit snugly against the user's shoulders, potentially providing stable support and reducing movement during use.

Next, the user may pass the first strap end of the carrying strap through the strap slot of the buckle. This may involve threading the first strap end through the strap slot from one side of the buckle to the other. In some cases, the first strap end may be passed through a locking rod extending across the strap slot, potentially providing additional security and adjustability for the carrying strap.

Once the first strap end has been passed through the strap slot, the user may secure the carrying strap along a portion of the large object. This may involve wrapping the carrying strap around the large object, or threading the carrying strap through a handle or opening on the large object. In some cases, the carrying strap may be secured along a portion of the large object by tying, buckling, or fastening the carrying strap.

After securing the carrying strap, the user may position the large object on the carrying strap. This may involve adjusting the position of the large object so that it is balanced on the carrying strap, potentially enhancing stability and control during transportation. In some cases, the user may adjust the position of the large object by sliding the large object along the carrying strap, or by adjusting the length of the carrying strap.

Next, the user may adjust the handle position so the large object is held by the carrying strap. This may involve pulling the handle to tighten the carrying strap around the large object, or sliding the handle along the carrying strap to adjust the position of the handle. In some cases, the handle position may be adjusted to provide a comfortable grip for the user, potentially enhancing control and reducing strain during use.

Finally, the user may carry the large object to a desired location. This may involve lifting the large object using the carrying strap and shoulder harness, and then walking or moving to the desired location. In some cases, the user may adjust the position or angle of the large object during transportation, potentially enhancing comfort and reducing strain.

In some aspects, the carrying strap may be secured to the large object by wrapping it around the object at least once. This wrapping method may provide a secure and adjustable connection between the carrying strap and the object, potentially enhancing stability and control during transportation. For example, the carrying strap may be wrapped around the object in a spiral or helical pattern, or it may be wrapped around the object in a crisscross or figure-eight pattern. In some cases, the carrying strap may be wrapped around the object multiple times, potentially providing additional security and adjustability.

In some embodiments, the carrying strap may include a strap fastener, such as a buckle, a hook and loop fastener, or a snap fastener, which may allow the user to secure the carrying strap after wrapping it around the object or allowing the user to attach the carrying strap to another part of the carrying device while the carrying device is worn but not in use. The fastener may be used to securely hold the carrying strap in place to prevent the strap from dangling and tripping the user. The fastener may alternately be used to preventing slippage and providing a secure connection between the carrying strap and the object. The handle end of the strap may be fastened against the shoulder harness to prevent it from dangling when the harness is not in use since the carrying device may still worn by the user while the user performs other tasks that do not require use of the carrying device or harness.

In some aspects, the user may adjust the handle position so the large object is held by the carrying strap. This adjustment may involve pulling the handle to tighten the carrying strap around the object, or sliding the handle along the carrying strap to adjust the position of the handle. In some cases, the handle position may be adjusted to provide a comfortable grip for the user, potentially enhancing control and reducing strain during use.

In some embodiments, the handle may include an adjustment mechanism, such as a buckle, a clamp, or a sliding knot, which may allow the user to easily adjust the handle position. The adjustment mechanism may be designed to securely hold the handle at a desired position, potentially providing stable support and preventing slippage during use.

In some cases, the handle may be designed to rotate or pivot relative to the carrying strap, potentially allowing the user to adjust the angle of the handle to fit their grip. This rotational or pivotal design may enhance the user's grip and control, potentially reducing strain and improving comfort during use. For example, the handle may be connected to the carrying strap by a swivel joint, a ball joint, or a hinge, which may allow the handle to rotate or pivot relative to the carrying strap.

Components include a shoulder harness. A buckle is attached to the harness. A flat strap is fed through the buckle so that it is now attached to the shoulder harness. A handle is attached to the opposite end of the flat strap. A means of adjusting the length of the flat strap is provided by using an adjustable buckle.

The design of the shoulder harness could vary but it is a means of supporting weight by the shoulders. The buckle design could vary. The strap length can be adjustable at the buckle or at the handle (but an adjustable buckle seems to work better). The handle design could vary. The size and shape of the flat strap could vary. Also, this device could work with weight distributed to the user's waist instead of the shoulders.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A carrying device for allowing a user to carry large objects, comprising:
a shoulder harness having a first strap for support with a left shoulder of a user and a second strap for support with a right shoulder of a user;
a buckle including:
a buckle base plate having a width and a height, the width larger than the height;
a strap slot disposed horizontally along the width of the buckle base plate; and
a first angled slot disposed adjacent a second angled slot, the first and second angled slots positioned above the strap slot;
a carrying strap having a first strap end for passing through the strap slot; and
a handle secured to a second strap end of the carrying strap, the second strap end opposite the first strap end;
wherein the shoulder harness is adjustably securable to the first and second angled slots; and
wherein the carrying strap is adjustably securable to the strap slot.

2. The carrying device of claim 1 including a locking rod extending across the strap slot wherein the carrying strap is adjustably securable to the strap slot by the locking rod.

3. The carrying device of claim 1 wherein the handle comprises a grip portion and a strap attachment portion, the strap attachment portion for securely connecting the handle to the second strap end.

4. The carrying device of claim 3 wherein the grip portion of the handle is ergonomically shaped to fit a hand of the user.

5. The carrying device of claim 1 wherein the shoulder harness further includes length adjustment on the first strap and the second strap to accommodate different user sizes.

6. The carrying device of claim 1 wherein the buckle base plate is made of a durable, lightweight material selected from the group consisting of aluminum, reinforced plastic, and titanium.

7. The carrying device of claim 6, wherein the buckle base plate further comprises reinforced edges to enhance structural integrity.

8. A method for carrying a large object, comprising:
providing a carrying device including:
a shoulder harness having a first strap for support with a left shoulder of a user and a second strap for support with a right shoulder of a user;
a buckle including a buckle base plate with a strap slot and first and second angled slots;
a carrying strap having a first strap end for passing through the strap slot; and
a handle secured to a second strap end of the carrying strap;
attaching the shoulder harness against shoulders of a user;
passing the first strap end through the strap slot;
securing the carrying strap along a portion of a large object;
positioning the large object on the carrying strap;
adjusting the handle position so the large object is held by the carrying strap; and
carrying the large object to a desired location.

9. The method of claim 8 further comprising adjusting a length of the first strap and the second strap of the shoulder harness to fit the user.

10. The method of claim 8 wherein securing the carrying strap along a portion of the large object comprises wrapping the carrying strap around the large object at least once.

11. The method of claim 10 wherein adjusting the handle position comprises pulling the handle to tighten the carrying strap around the large object.

12. The method of claim 8 wherein the carrying device includes a locking rod disposed on the buckle extending across the strap slot for locking the carrying strap in the strap slot and the method includes passing the first strap end through the strap slot against the locking rod and locking the carrying strap in the strap slot.

13. The method of claim 12 wherein adjusting the handle position comprises sliding the carrying strap through the strap slot and locking rod to adjust the length of the carrying strap supporting the large object.

14. The method of claim 8 wherein the large object is selected from the group consisting of a mattress, a piece of furniture, a large appliance, and a bundle of construction materials.

15. A method for carrying a large object, comprising:
providing a carrying device including:
a shoulder harness having a first strap for support with a left shoulder of a user and a second strap for support with a right shoulder of a user;
a buckle including a buckle base plate with a strap slot and first and second angled slots;
a carrying strap having a first strap end for passing through the strap slot; and
a handle secured to a second strap end of the carrying strap;
attaching the shoulder harness against shoulders of a user;
adjusting a length of the first strap and the second strap of the shoulder harness to fit the user;
securing the carrying strap along a portion of a large object;
passing the first strap end through the strap slot;
positioning the large object on the carrying strap;
adjusting the handle position so the large object is held by the carrying strap; and
carrying the large object to a desired location.

16. The method of claim 15 wherein securing the carrying strap along a portion of the large object comprises wrapping the carrying strap around the large object at least once.

17. The method of claim 15 wherein adjusting the handle position comprises pulling the handle to tighten the carrying strap around the large object.

18. The method of claim 15 wherein the carrying device includes a locking rod disposed on the buckle extending across the strap slot for locking the carrying strap in the strap slot and the method includes passing the first strap end through the strap slot against the locking rod and locking the carrying strap in the strap slot.

19. The method of claim 18 wherein adjusting the handle position comprises sliding the carrying strap through the strap slot and locking rod to adjust the length of the carrying strap supporting the large object.
